(19) United States
(12) Patent Application Publication
(10) Pub. No.: US 2023/0357486 A1
(43) Pub. Date: Nov. 9, 2023

(54) COATING SYSTEMS AND METHODS FOR COATING LARGE COMPONENTS

(71) Applicant: MANKIEWICZ GEBR. & CO. (GMBH & CO. KG), HAMBURG (DE)

(72) Inventors: KARL WERNER GEBHARD, BREESE (DE); PASCAL MIDDELSTAEDT, RADBRUCH (DE)

(73) Assignee: MANKIEWICZ GEBR. & CO. (GMBH & CO. KG), HAMBURG (DE)

(21) Appl. No.: 18/024,779

(22) PCT Filed: Sep. 7, 2021
(86) PCT No.: PCT/DE2021/100738

§ 371 Date: Mar. 6, 2023

(30) Foreign Application Priority Data
Sep. 7, 2020 (DE) 10 2020 005 446.3

(51) Int. Cl. C09D 175/02; C08G 18/08; C08G 18/00; C08G 18/79; C08G 18/38

(52) U.S. Cl. CPC C08G 18/798; C08G 18/003; C08G 18/0885; C08G 18/3821; C09D 175/02; C08G 2150/90

(57) ABSTRACT

A coating system includes at least one putty layer and at least one clear coat layer. The at least one putty layer includes a putty having a binder component which has at least one polyaspartic acid ester and a hardener component which has at least one polyisocyanate. The at least one clear coat layer includes a clear coat coating material based on an RMA binder or a polyaspartic acid ester binder.

### CROSS REFERENCE TO PRIOR APPLICATIONS

This application is a U.S. National Phase application under 35 U.S.C. § 371 of International Application No. PCT/DE2021/100738, filed on Sep. 7, 2021 and which claims benefit to German Patent Application No. 10 2020 005 446.3, filed on Sep. 7, 2020. The International Application was published in German on Mar. 10, 2022 as WO 2022/048711 A1 under PCT Article 21(2).

### FIELD

The present invention relates to coating systems having one putty layer based on polyaspartic acid ester binders and one clear coat layer based on RMA binders or polyaspartic acid ester binders. The present invention further relates to improved methods for producing these coating systems, which are in particular employed for coating very large objects such as machines, components or vehicles, for example, for coating railway carriages, cranes, excavators or dump trucks.

### BACKGROUND

Coating structures or coating systems consisting of four to five layers are usually employed for coating the above mentioned objects. The coating of a railway carriage has, for example, coating systems with a primer layer, a putty layer, a filler layer and a top coat layer. The top coat layer may be substituted by customary base coat/clear coat systems.

In order to construct the coating system, the primer layer is first applied to a prepared and cleaned substrate surface. The term “primer” is defined hereafter as thin layers which are directly applied to the substrate surface, i.e., metal surfaces, and which are used in coating systems as a primer with certain functions such as adhesion promotion and corrosion protection. In order to produce the primer layer, coating materials based on epoxy resin binders or polyurethane binders which must be cured at high temperatures are usually employed.

A putty is applied to the primer layer, then cured, and subsequently ground. The term “putty” is defined hereafter as highly filled coating material compositions leading to coatings which may be ground without major problems. They may be employed to compensate for larger irregularities of the surface. Putties which are conventionally used are compositions on the basis of unsaturated polyester binders which must be applied to the primer layer manually via a spatula. While the putty layers obtained may be ground without major problems, they show an undesirably high moisture absorption which impairs further processing.

One or more filler layers are applied in order to smooth the surface of the partially ground putty layer. One or more coloring lacquers and, optionally, one or more clear coat layers, normally follow, depending upon the desired decorative design. The term “filler” is defined hereafter as coating material compositions which are employed to compensate for smaller irregularities of the surface, such as striae resulting from grinding. Conventional fillers are compositions based on polyurethane binders or epoxy resin binders, which are cured at high temperatures. The term “coloring lacquer” is defined hereafter as a coating material which results in a colored coating after having been applied to a substrate. The term “clear coat” is defined hereafter as a coating material leading to a transparent coating with protective, decorative and/or specific technical properties.

The customary coloring lacquer layers are produced from pigmented coating materials based on polyurethane binders which are cured at high temperatures. One or more clear coat layers may furthermore additionally be applied to these layers in order to protect the coating and to improve its properties.

Due to the fact that four to five layers are necessary, the production of known coating systems is both material-consuming and time-consuming. There is also a high energy demand due to the necessary curing of the separate layers at high temperature.

### SUMMARY

An aspect of the present invention is to provide improved coating systems and methods for their production, in particular methods which require less consumption of material, time and energy.

In an embodiment, the present invention provides a coating system which includes at least one putty layer and at least one clear coat layer. The at least one putty layer comprises a putty which comprises a binder component which comprises at least one polyaspartic acid ester and a hardener component comprising at least one polyisocyanate. The at least one clear coat layer comprises a clear coat coating material based on an RMA binder or a polyaspartic acid ester binder.

### DETAILED DESCRIPTION

The coating systems according to the present invention contain one or more putty layers as well as one or more clear coat layers. The putty layers are made of putties with a binder component having one or more polyaspartic acid esters, and a hardener component having one or more polyisocyanates. The clear coat layers are made of clear coat coating materials based on RMA binders or polyaspartic acid ester binders.

The term “coating system” is defined hereafter as the construction of a coating onto a substrate, with the construction exhibiting at least two layers. The layers are obtained by applying a coating material and the subsequent curing or drying thereof to obtain a continuous, solid layer. The term “RMA binder” is defined hereafter as binder systems which cross-link in a Michael addition. They have CH acid compounds as an RMA donor, vinylogous carbonyl compounds as an RMA acceptor, and latent base catalysts.

In an embodiment of the present invention, the coating system further comprises at least one layer of coloring lacquer that is applied to the putty layer(s). The employed coloring lacquers can, for example, contain RMA binders or polyaspartic acid ester binders. At least one clear coat layer is then applied to the layer(s) of coloring lacquer.

The putties have a running limit in the range of 200 to 1,200 µm, for example, from 250 to 1,000 µm, for example, from 275 to 900 µm, for example, from 300 to 750 µm. The term “running limit” is defined hereafter as the wet film thickness specified in micrometers above which a coating material sprayed onto a perpendicular surface begins to run. The wet film thickness is defined as the layer thickness of the applied, uncured coating material.

The putties also have structural viscosity values of 35 to 85, for example, of 45 to 75, for example, of 50 to 70. The term “structural viscosity value” is defined hereafter as the ratio of the shear viscosity of the coating material at a shear rate of 0.1/s to the shear viscosity at a shear rate of 1,000/s. Shear viscosity for this purpose is measured via a rotary viscosimeter in mPas at 23° C.

The putties may be applied in a high layer thickness via customary spraying methods. It is also possible to construct coatings with thick layers in one step. Their drying time is significantly shorter than the drying time of conventionally used putties. Being cured at room temperature (23° C.), the putties become a grindable layer already two hours after their application. The putty layers obtained also show a high resistance to chemicals and weathering, a high elasticity and good grindability. After having been ground, the surface of the putty layer is so even and uniform that applying smoothing filler layers is not necessary.

Due to their adhesion properties, the putties may also be applied directly to substrate surfaces, in particular to metal surfaces, so that corresponding primer layers might be dispensed with. The putties may be applied by common spraying methods in a low-pressure process, a high-pressure process, and a ultrahigh-pressure process, which can also be electrostatically assisted.

The putties according to the present invention have a binder component and a hardener component, with the binder component containing one or more polyaspartic acid esters and one or more fillers. The hardener component contains one or more polyisocyanates.

Polyaspartic acid esters according to formula (I) are suitable in accordance with the present invention,

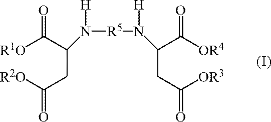

with R¹, R², R³ and R⁴ independently of one another representing hydrogen, alkyl or aryl groups, and R⁵ representing a divalent alkyl, aralkyl, aryl or cycloalkyl group.

The polyaspartic acid esters N,N′-(methylenedi-4,1-cyclohexanediyl)bis-1,1′,4,4′-tetraethyl ester, N,N ‘-[methylene-bis(2-methyl-4,1-cyclohexanediyl)]bis-1,1’,4,4′-tetraethyl ester, N,N′-(2-methyl-1,5-pentanediyl)bis-,1,1 ′,4,4 ‘-tetraethyl ester, and mixtures thereof can, for example, be used. The polyaspartic acid esters are used in quantities from 5 to 50 wt.-%, for example, from 10 to 40 wt.-%, for example, from 20 to 25 wt.-%, with the quantities referring in each case to the total weight of the putty.

Suitable fillers are carbonates such as chalk, limestone powder, calcite, precipitated calcium carbonate, dolomite, barium carbonate, sulfates such as baryte, Blanc fixe, calcium sulfate, talc, chlorite, kaolin, wollastonite, montmorillonite, slate powder, feldspar, mullite, pumice powder, perlite, fibers from melts of glass or basalts, glass powder, glass spheres, slags, and mixtures thereof. Fillers which can, for example, be used are barium sulfate, talc, and mixtures thereof. According to the present invention, the fillers are used in quantities from 0.01 to 50 wt.-%, for example, from 5 to 40 wt.-%, for example, from 10 to 30 wt.-%, with the quantities referring in each case to the total weight of the putty.

Polyisocyanates based on aliphatic diisocyanates such as hexamethylene-1,6-diisocyanate (abbreviated: HDI) and isophorone diisocyanate (abbreviated: IPDI) are suitable. The oligomers uretdione, isocyanurate, allophanate, biuret, iminooxadiazinedinone, and mixtures thereof can, for example, be used. HDI uretdiones, HDI isocyanurates, HDI allophanates, HDI biurets, HDI iminooxadiazinedinones, IPDI uretdiones, IPDI isocyanurates, IPDI allophanates, IPDI biurets, IPDI iminooxadiazinedinones, and mixtures thereof can, for example, be used. HDI uretdiones, HDI isocyanurates, IPDI uretdiones, IPDI isocyanurates and mixtures thereof can, for example, be used.

The binder component and the hardener component are used in a molar ratio A : B of the isocyanate-functional groups of the polyisocyanates (A) to the amino-functional groups of the polyaspartic acid esters (B) in the range of 0.5 : 1 to 2 : 1, for example, from 0.6 : 1 to 1.8 : 1, for example, from 0.7 : 1 to 1.7 : 1, for example, from 0.8 : 1 to 1.6 : 1.

The putties have low VOC values. The VOC value is defined as the content of volatile organic components (Volatile Organic Components) having a boiling temperature of equal to or less than 250° C. at 101.3 kPa. The solids contents of the putties are in the range of 70 to 100 %, for example, 80 to 100 %, for example, 90 to 100 %. The term “solids content” is defined hereafter as the percentage by mass of a coating material which remains as residue after evaporation.

The putties have a filling level in the range of 30 to 50 %, for example, 33 to 47 %, for example, 35 to 45 %, for example, 37 to 43 %. The term “filling level” is defined hereafter as the percentage by mass of insoluble solid substances being existent in the uncured putty, based on the total mass of the putty.

In a further embodiment of the present invention, the putties can, for example, additionally contain up to 30 wt.-%, for example, from 0.01 to 20 wt.-%, for example, 0.01 to 10 wt.-%, of aprotic solvents, with the quantities referring in each case to the total weight of the putty. The term “aprotic solvent” is defined hereafter as solvents containing no ionizable proton in the molecule. Suitable aprotic solvents are, for example, aliphatic hydrocarbons, cycloaliphatic hydrocarbons, aromatic hydrocarbons, ketones, esters, ethers and ether esters. Ethyl acetate, butyl acetate, acetone, n-butanone, methyl isobutyl ketone, diisobutyl ketone, methoxypropyl acetate, dimethyl sulfoxide, and mixtures thereof can, for example, be used. Ethyl acetate, butyl acetate, acetone, n-butanone, methyl isobutyl ketone, methoxypropyl acetate, diisobutyl ketone, and mixtures thereof are solvents which can, for example, be used.

In a further embodiment of the present invention, the putties can, for example, further contain adhesion promotors, for example, in the hardener component. Suitable adhesion promotors are silanes such as 3-glycidyloxypropyltriethoxysilane (GLYEO), 3-glycidyloxypropyltrimethoxysilane (GLYMO), 2-aminoethyl-3-aminopropyltrimethoxysilane, 2-aminoethyl-3-amino-propylmethyldimethoxysilane, N-(n-butyl)-3-aminopropyltrimethoxysilane, bis(3-triethoxysilylpropyl)-amine, bis(3-trimethoxysilylpropyl)amine, 3-aminopropylmethyldiethoxysilane, 3-aminopropyltriethoxysilane (AMEO), 3-aminopropyltrimethoxysilane (AMMO) and mixtures thereof. 3-glycidyloxypropyltriethoxysilane (GLYEO), 3-glycidyloxypropyltrimethoxysilane (GLYMO), 3-aminopropyltriethoxysilane (AMEO), 3-aminopropyltrimethoxysilane (AMMO), and mixtures thereof can, for example, be used.

In an embodiment of the present invention, the putties can, for example, additionally contain corrosion inhibitors. The putties may thus be directly applied to the metal substrates as a so-called direct-to-metal-coating so that primer layers are no longer necessary. Suitable corrosion inhibitors are tannin derivatives, basic sulfonates, nitrocarboxylates, aminocarboxylates, as well as zinc salts of organic nitrogen acids such as zinc-nitroisophthalate and zinc salts of cyanuric acid. Other suitable corrosion inhibitors are passive anti-corrosion pigments such as iron mica and aluminum pigments. Likewise suitable are active anti-corrosion pigments such as phosphates, e.g., zinc phosphate, phosphosilicates, e.g., calcium-strontium-phosphosilicates, borates, molybdates and chromates, which bring about electrochemical passivation of the metal surface. These can be surface-treated, for example, silanized. It is also possible to use calcium or magnesium silicates on a base material. According to the present invention, zinc phosphate, calcium-strontium-phosphosilicates, calcium silicates or magnesium silicates on a base material, and mixtures thereof can, for example, be used. The corrosion inhibitors according to the present invention are used in quantities of up to 30 wt.-%, for example, 0.1 to 30 wt.-%, for example, 5 to 25 wt.-%, for example, 10 to 20 wt.-%, with the quantities referring in each case to the total weight of the putty.

In an embodiment of the present invention, the putties can, for example, further contain organic and/or inorganic color pigments. The putties thus additionally assume the function of the coloring lacquer layer. Suitable pigments are titanium dioxide, iron oxides, chromium oxides, chromium titanates, bismuth vanadate, cobalt blue, carbon black, Pigment Yellow 151, Pigment Yellow 213, Pigment Yellow 83, Pigment Orange 67, Pigment Orange 62, Pigment Orange 36, Pigment Red 170, Pigment Red 188, Pigment Red 254, Pigment Violet 19, Pigment Violet 23, Pigment Blue 15:3, Pigment Blue 15:6, Pigment Green 7, and mixtures thereof. Titanium dioxide, carbon black, Pigment Orange 62, Pigment Red 188, Pigment Red 254, Pigment Violet 23, Pigment Blue 15:3, Pigment Blue 15:6, and mixtures thereof can, for example, be used. The pigments according to the present invention are used in quantities of up to 40 wt.-%, for example, 0.01 to 40 wt.-%, for example, 0.01 to 30 wt. %, for example, 1 to 20 wt.-%, with the quantities referring in each case to the total weight of the putty.

In an embodiment of the present invention, the putties can, for example, additionally contain light stabilizers in order to obtain long weathering resistance. Suitable light stabilizers are free-radical scavengers such as sterically hindered aliphatic amines, for example, on the basis of substituted 2,2,6-tetramethylpiperidines, UV absorbers such as 2-hydroxyphenylbenzotriazoles, 2-hydroxybenzophenones, 2-hydroxyphenyltriazines or oxalanilides, as well as quenching agents such as organic nickel compounds and peroxide decomposers such as thioethers or phosphites. Sterically hindered aliphatic amines based on substituted 2,2,6-tetramethylpiperidines, 2-hydroxyphenylbenzotriazoles, 2-hydroxybenzophenones, 2-hydroxyphenyltriazines, oxalanilides, and mixtures thereof can, for example, be used. Substituted 2,2,6,6- tetramethylpiperidines, 2-hydroxyphenyltriazines, 2-hydroxybenzophenones, oxalanilides, and mixtures thereof can, for example, be used. The light stabilizers according to the present invention are used in quantities of up to 5 wt.-%, for example, 0.01 to 2 wt.-%, for example, 0.1 to 1 wt.-%, with the quantities referring in each case to the total weight of the putty.

In an embodiment of the present invention, the putties can, for example, further contain drying agents. Drying agents are substances which are suitable for absorbing moisture, in particular water, and which are mainly employed for drying gases, liquids and solids. A molecular sieve such as synthetic and natural zeolites, oxazolidinones, orthocarboxylic acid esters, blocked amines such as aldimines or ketimines, and mixtures thereof can, for example, be used as drying agents. Synthetic zeolites, cycloaliphatic aldimines or ketimines, and mixtures thereof can, for example, be used. The drying agents according to the present invention are used in quantities of up to 25 wt.-%, for example, 0.1 to 25 wt.-%, for example, 1 to 20 wt.-%, for example, 5 to 15 wt.-%, with the quantities referring in each case to the total weight of the putty.

The putties may also contain the customary auxiliary agents and additives familiar to the person skilled in the art, such as wetting agents, rheology additives, adhesion promotors, flow-improving additives, defoamers and deaerators. The additives and auxiliary agents may be employed in quantities of up to 15 wt.-%, for example, 0.02 to 15 wt.-%, for example, 0.2 to 10 wt.-%, for example, 0.5 to 8 wt.-%, in each case based on the total mass of the putty.

Due to its properties, the coating system according to the present invention can be applied directly to the substrate surfaces, in particular of metal substrates, without any further primer or primer layer.

The present invention also provides a method for producing the coating system, in which in step (a) at least one putty layer selected from the putties according to the present invention is applied to a substrate surface, in step (b) the cured putty layer is ground, and in step (c) at least one clear coat layer is subsequently applied to this putty layer.

The term “applying a coating” is defined hereafter as the application of a coating material composition to a surface, directly to the substrate or to a coating, with subsequent curing to obtain a coating.

After the usual cleaning of the substrate surface, the putty according to the present invention is applied by spraying in a low-pressure plant, high-pressure plant or ultrahigh-pressure plant, and is subsequently cured at room temperature. In a further embodiment, the putty can, for example, be applied to a primer layer which has been applied to the substrate surface.

In a further embodiment, putties can, for example, be employed which have one or more colored pigments. They may additionally contain one or more light stabilizers. The pigmented putties may be substituted for the coloring lacquer layer(s) so that no further layers are required.

The cured putty layer is smoothed. The clear coat coating materials are subsequently applied and cured. The clear coats employed according to the present invention, which are based on RMA binders or polyaspartic acid ester binders, may be cured at room temperature. The clear coat coating materials have a solids content of at least 65 %, for example, 70 %, for example, at least 80 %, for example, at least 90 %, in order to keep the VOC values of the entire coating system as low as possible.

A further embodiment of the method according to the present invention describes an additional step in which at least one coloring lacquer layer is first applied to the smoothed putty layer. At least one clear coat is subsequently applied to the coloring lacquer layer. Coloring lacquers on the basis of RMA binders can, for example, be employed. Coloring lacquers on the basis of RMA binders or polyaspartic acid ester binders which can be cured at room temperature can, for example, be employed. By applying the final clear coat layer according to the present invention, which is made of clear coats based on polyaspartic acid ester binders, light-resistant coatings are obtained, the surfaces of which have very good visual properties.

### EXAMPLES

### Coating Systems According to the Present Invention

### Example 1: Putties

Composition 1.1

| Component | Part by Weight |
|---|---|
| Binder Component | |
| Polyaspartic acid ester: N,N′-(methylenedi-4,1-cyclohexanediyl)bis-1,1`,4,4′-tetraethyl ester | 32.0 |
| Drying agent: Aldimine made of Isophorone diamine and butanal | 2.5 |
| Drying agent: Molecular sieve 3A | 8.0 |
| Filler: Talc | 48.0 |
| Rheology additive: Thickener on the basis of hydrogenated castor oil | 1.8 |
| Defoamer: Polyacrylate block copolymer | 0.5 |
| Dispersant: Polyacrylate with pigment-affine groups | 3.0 |
| Solvent: Butyl acetate | 4.2 |
| Hardener Component | |
| Polyisocyanate: HDI uretdione | 32.0 |
| Adhesion promotor: 3-glycidyloxypropyltriethoxysilane | 2.0 |

Composition 1.2 (Direct-to-Metal)

| Component | Part by Weight |
|---|---|
| Binder Component | |
| Polyaspartic acid ester: N,N′-(methylenedi-4,1-cyclohexanediyl)bis-1,1`,4,4′-tetraethyl ester | 32.0 |
| Drying agent: Aldimine made of Isophorone diamine and butanal | 2.5 |
| Drying agent: Molecular sieve 3A | 8.0 |
| Filler: Talc | 30.0 |
| Corrosion inhibitor: Zinc phosphate | 18.0 |
| Rheology additive: Thickener on the basis of hydrogenated castor oil | 1.4 |
| Defoamer: Polyacrylate block copolymer | 0.5 |
| Dispersant: Polyacrylate with pigment-affine groups | 3.0 |
| Solvent: Butyl acetate | 4.6 |
| Hardener Component | |
| Polyisocyanate: HDI uretdione | 32.0 |
| Adhesion promotor: 3-glycidyloxypropyltriethoxysilane | 2.0 |

Composition 1.3 (Coloring, Direct-to-Metal)

| Component | Part by Weight |
|---|---|
| Binder Component | |
| Polyaspartic acid ester: N,N′-(methylenedi-4,1-cyclohexanediyl)bis-1,1`,4,4′-tetraethyl ester | 32.0 |
| Drying agent: Aldimine made of Isophorone diamine and butanal | 2.5 |
| Light stabilizer: Sterically hindered aliphatic amine on the basis of substituted 2,2,6-tetramethylpiperidine | 1.0 |
| Drying agent: Molecular sieve 3A | 8.0 |
| Filler: Talc | 21.0 |
| Corrosion inhibitor: Zinc phosphate | 18.0 |
| White pigment: Titanium dioxide | 2.5 |
| Colored pigment: Pigment Orange 62 | 2.5 |
| Colored pigment: Pigment Red 188 | 2.5 |
| Rheology additive: Thickener on the basis of hydrogenated castor oil | 1.9 |
| Defoamer: Polyacrylate block copolymer | 0.5 |
| Dispersant: Polyacrylate with pigment-affine groups | 3.0 |
| Solvent: Butyl acetate | 4.6 |
| Polyisocyanate: HDI uretdione | 32.0 |
| Adhesion promotor: 3-glycidyloxypropyltriethoxysilane | 2.0 |

### Example 2: Clear Coats

Composition 2.1

| Component | Part by Weight |
|---|---|
| Binder Component | |
| Polyaspartic acid ester | 81.93 |
| Drying agent | 16.87 |
| Light stabilizer | 0.60 |
| Additives | 0.60 |
| Hardener Component | |
| Polyisocyanate | 88.05 |
| Adhesion promotor | 3.85 |

Composition 2.2

| Component | Part by Weight |
|---|---|
| Binder Component | |
| Polyaspartic acid ester | 68.00 |
| Drying agent | 14.00 |
| Light stabilizer | 0.50 |
| Additives | 0.50 |
| Solvent | 17.00 |
| Hardener Component | |
| Polyisocyanate | 73.08 |
| Adhesion promotor | 3.85 |

Composition 2.3

| Component | Part by weight |
|---|---|
| Binder component | |
| Malonate polyester | 60.00 |
| Ditrimethylolpropane tetraacrylate | 10.00 |
| Pentaerythritol triacrylate | 16.00 |
| Light stabilizer | 1.00 |
| Additives | 0.20 |
| Ethanol | 3.00 |
| Solvent | 9.80 |
| Ammonium monoethyl carbonate | 4.00 |

The present invention is not limited to embodiments described herein; reference should be had to the appended claims.

What is claimed is:

1-10. (canceled)

11. A coating system comprising:
at least one putty layer, the at least one putty layer comprising a putty which comprises a binder component which comprises at least one polyaspartic acid ester and a hardener component comprising at least one polyisocyanate; and
at least one clear coat layer, the at least one clear coat layer comprising a clear coat coating material based on an RMA binder or a polyaspartic acid ester binder.

12. The coating system as recited in claim 11, wherein the putty has a structural viscosity value of from 35 to 85.

13. The coating system as recited in claim 11, wherein the putty has a running limit of from 200 µm to 1,200 µm.

14. The coating system as recited in claim 11, wherein the putty further comprises at least one corrosion inhibitor.

15. The coating system as recited in claim 11, wherein the putty further comprises at least one colored pigment.

16. A method of using the coating system as recited in claim 11, the method comprising:
providing the coating systema as recited in claim 11;
providing a metal; and
coating the metal with the coating system.

17. A method for producing the coating system as recited in claim 11, the method comprising:
directly or indirectly applying at least one putty layer to a substrate surface;
grinding the at least one putty layer so as to obtain a ground putty layer; and
directly or indirectly applying at least one clear coat layer to the ground putty layer.

18. The method as recited in claim 17, further comprising:
applying at least one primer layer to the substrate surface; and then
applying the at least one putty layer to the at least one primer layer.

19. The method as recited in claim 17, further comprising:
applying at least one coloring lacquer layer to the ground putty layer; and then
applying the at least one clear coat layer to the at least one coloring lacquer layer.

20. The method as recited in claim 19, wherein,
a coloring lacquer is used to produce the at least one coloring lacquer layer, and
the coloring lacquer contains the RMA binder.
